(19) United States
(12) Patent Application Publication
(10) Pub. No.: US 2021/0119913 A1
(43) Pub. Date: Apr. 22, 2021

(54) ROUTING CONTROL IN EXTERNAL AUTONOMOUS SYSTEM BY USING CUSTOMER-SPECIFIC TUNNEL

(71) Applicant: Algoblu Holdings Limited, Grand Cayman (KY)

(72) Inventor: Ming LI, Beijing (CN)

(21) Appl. No.: 16/661,772

(22) Filed: Oct. 23, 2019

(30) Foreign Application Priority Data
Oct. 18, 2019 (CN) 201910985979.5

(51) Int. Cl. H04L 12/721; H04L 12/715

(52) U.S. Cl. CPC H04L 45/66; H04L 45/566; H04L 45/64

(57) ABSTRACT

System and method of controlling data routing across autonomous systems without causing source IP address of a data packet to change. In a first autonomous system, a tunnel on an overlay network and having a predefined route is pre-assigned to a second autonomous system. When the first autonomous system receives a data packet having an IP address associated with the second autonomous system, the data packet is tagged to indicate the associating. Once locating the tag in the packet, a network switch in the first autonomous system performs layer 2 port forwarding to forward the data to an end point port of the pre-assigned tunnel and thereby the data can traverse the tunnel to the other tunnel endpoint port, which may be an edge node of the first autonomous system. In this manner, the data packet can traverse the first autonomous system while preserving the original source IP address.

### TECHNICAL FIELD

The present disclosure relates generally to the field of network traffic routing, and, more specifically, to the field of routing across multiple autonomous systems.

### BACKGROUND OF THE INVENTION

An autonomous system (AS) refers to a network or a collection of networks that are administrated by an entity or organization, which may be an Internet service provider (ISP) or a customer entity that subscribes service from an ISP. Typically, an AS has its own AS identification and is a heterogeneous network having many subnetworks with combined routing logic and common routing policies. An AS usually uses multiple ingress and egress edge nodes to interface with other autonomous systems. Outbound data traffic of an autonomous system may go through a designated egress edge node to reach the destination node in another autonomous system.

Border Gateway Protocol (BGP) is a standardized exterior gateway protocol designed to exchange routing and reachability information among autonomous systems on the Internet. The BGP is used to make routing decisions based on paths, network policies or rule-sets configured by a network administrator. The BGP may be used for routing within an autonomous system or across multiple autonomous systems.

Conventionally, data packets that travel through an AS are assigned with IP addresses associated with the AS by the routers. For example, when a data packet originates from a customer AS, a router assigns a private source IP address that belongs to the customer entity. When the packet reaches the ISP AS, a router in the ISP AS performs network address translation (NAT) and maps the private IP address to a public IP address that belongs to the ISP, for example through static NAT or dynamic NAT. When a data packet is routed back to the source device in the customer AS, the ISP router reverses the translation and changes the public IP address to the private IP address. Data routing within the ISP AS is determined by the router in the ISP according to various routing mechanisms, typically by using a routing table, and the routing may be adjusted dynamically.

Further, when a packet arrives at the destination node which may be located in a third AS, it is treated as that data packet has the IP address associated with the ISP AS, without regard to the original private IP address associated with the customer AS. This may raise certain issues in some applications. For example, the destination node may be located in a secured corporate network and rely on the IP address of the packet to determine whether it has adequate security level. Further, some corporate AS may have a firewall and require authentication, changing the source IP address conceals it source and may hinder the authentication process.

Usually it is difficult for an owner entity of an AS to control routing in an external AS. If a first ISP (e.g., Verizon) tries to preserve its IP addresses for the data traversing the second ISP AS (e.g., AT&T) or tries to have the data traversing the second ISP in a specified route, whether the data is destined for the second ISP or for a third ISP via the second ISP, the second ISP has to configure its routers individually to define the route as specified by the first ISP.

### SUMMARY OF THE INVENTION

Therefore, it would be advantageous to provide a mechanism that allows data packets to propagate across autonomous systems without changing the IP address that is assigned in the original or source autonomous system (AS). It would also be advantageous to offer a source AS some level of control over data routing in another AS.

Embodiments of the present disclosure involve, at the boundary of an instant AS (e.g., an ISP AS), forwarding data received from a specific external AS to a pre-assigned tunnel by way of policy-based port forwarding at Layer 2. The tunnel may be specific to an external AS (e.g., a customer AS), an application or a data group of any predefined sort. The tunnel is configured on an overlay network in the instant AS. Particularly, for a data packet routed from the external AS, a BGP router, a core router or another type of router of the instant AS analyzes the packet to determine whether it should be routed through the tunnel and accordingly forward the data to the port at the tunnel end.

In some embodiments, a BGP router of the instant AS can add a tag to the packet to indicate its association with the external AS, the application or the data group. Determination of whether the data should be forwarded to the tunnel may be based on various factors, such as the MAC address and quintuple (5-tuple), e.g., the source IP address/port number, the destination IP address/port number and the protocol in use. In other words, the tag is used to indicate association with the tunnel.

The BGP router is also configured with port forwarding policies and sends the packet to a switch. Based on the packet analysis result of based on the tag, the switch device performs layer 2 port forwarding to forward the data from a received Layer 2 port to a Layer 2 port that corresponds to the endpoint port of the pre-assigned tunnel. As a result, the packet is routed across the instant AS through the tunnel. The switch device may be a programmable network switch in a software defined networking in a wide area network (SD-WAN).

The tunnel includes predefined links within the instant AS, which may be pre-selected by the entity of the external AS, e.g., a customer AS. Information regarding the tunnel can be exchanged at the boundaries of the two ASs through BGP. The tunnel may have another endpoint at a non-edge node or an egress edge node of the instant AS. Thus, the external AS is advantageously offered with controlling capability with regard to data routing within the instant AS based on various business needs. Since any routing change can be performed by tunnel reconfiguration, it does not require changing a routing table by the instant AS for the specific external entity which is difficult in practice. In the case that the instant AS is administered by an Internet Service provider (ISP) and the external AS is controlled by a customer of the ISP, using an overlay network in combination with Layer 2 port forwarding allows the customer entity to control the routing in the ISP AS without imposing substantial operational cost of both parties. Further, since the data routing is controlled by port forwarding operations at Layer 2 (e.g., by using a Layer 2 switch) instead of using a routing table as in Layer 3 routing operations, the data exiting the tunnel can advantageously preserve its source IP address.

The data packet may also be further routed to a third AS, which may also have a tunnel configured for the external AS (the customer AS in the above-mentioned example). Similarly, the packet can traverse the third AS by way of the tunnel after port forwarding.

The foregoing is a summary and thus contains, by necessity, simplifications, generalization and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates an exemplary communication system in which data routing in the present autonomous system can be controlled by an external entity that is associated with an external autonomous system by using tunneling and Layer 2 port forwarding in accordance with an embodiment of the present disclosure.

FIG. 2 is a flow chart depicting an exemplary computer implemented process of routing data received from an external AS by using a pre-assigned tunnel built on an overlay network in accordance with an embodiment of the present disclosure.

FIG. 3 is a block diagram illustrating an exemplary architecture of an SDN configured to route data for an external-AS by use of Layer 2 port forwarding to a pre-assigned tunnel in accordance with an embodiment of the present disclosure.

FIG. 4 is a block diagram illustrating the configuration of an exemplary SDN central controller device capable of controlling network devices to route external AS data by using Layer 2 port forwarding to a pre-assigned tunnel according to an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. Although a method may be depicted as a sequence of numbered steps for clarity, the numbering does not necessarily dictate the order of the steps. It should be understood that some of the steps may be skipped, performed in parallel, or performed without the requirement of maintaining a strict order of sequence. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Routing Control in External Autonomous System by Using Customer-Specific Tunnel

Embodiments of the present disclosure provide a mechanism for an entity to control data routing in an external autonomous system (the first AS) by using a tunnel pre-assigned to an autonomous system (the second AS) associated with the entity. The tunnel is configured on an overlay network in the first AS. At a boundary of the first AS, data received from the second AS can be analyzed and optionally tagged, and then accordingly forwarded to the tunnel through Layer 2 port forwarding operations without subject to IP address change. For data received from the second AS, routing in the first AS can be adjusted by reconfiguring the tunnel rather than changing a routing table.

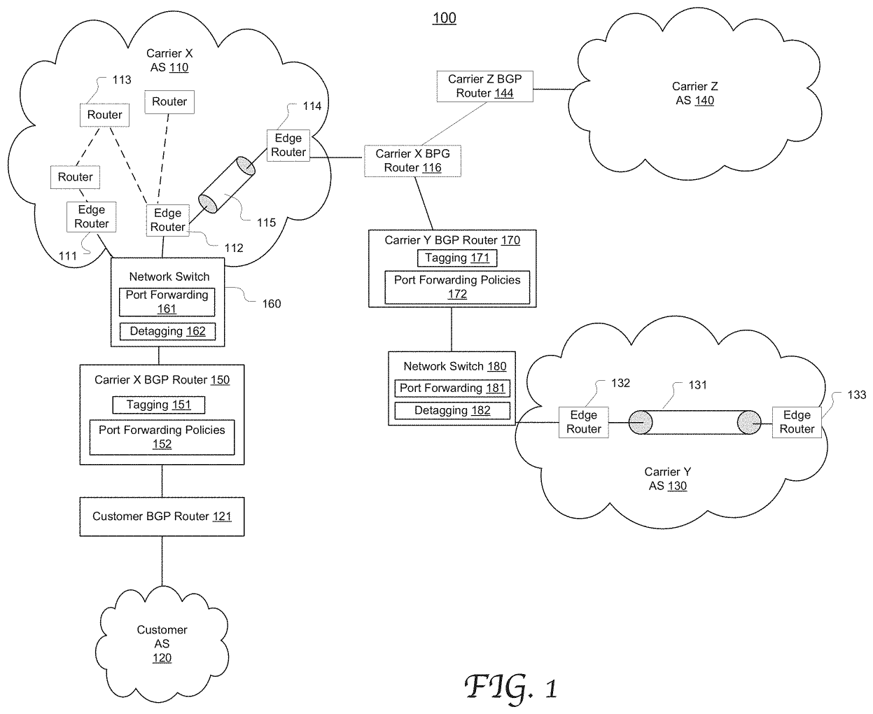

FIG. 1 illustrates an exemplary communication system 100 in which data routing in the present autonomous system can be controlled by an external entity that is associated with an external autonomous system by using tunneling and Layer 2 port forwarding in accordance with an embodiment of the present disclosure. As show, the autonomous systems (AS) 110, 130 and 140 correspond to networks of Carriers X, Y and Z, respectively, each carrier coupled to a core network (not explicitly shown). The core network may be a public access network such as the Internet, a physically separate intranet, or other interconnection. The core network may include other ASs. Each AS 110, 120, 130 or 140 is a routing domain, either a single network or a group of networks that is controlled by a common network administrator (or group of administrators) on behalf of a single administrative entity (such as a university, a business enterprise, or a business division). Each autonomous system may be assigned with a globally unique number, sometimes called an Autonomous System Number (ASN).

For instance, a data packet originating from the Customer AS 120 needs to travel across Carrier X AS 110 before reaching the destination node. Border Gateway Protocol (BGP) may be used to exchange routing and reachability information between the autonomous systems 120 and 110 on the Internet. The BGP may be used to make routing decisions based on paths, network policies or rule-sets configured by a network administrator. The BGP may be used for routing within an autonomous system as well as across multiple autonomous systems.

The Carrier X AS 110 may be a software defined networking (SDN) in a wide area network (SD-WAN). The Carrier X AS 110 is configured with an overlay network or an SDN overlay (not explicitly shown). The overlay network includes one or more layers of network abstraction that can be used to run multiple separate, discrete virtualized network layers on top of the physical network. One or more tunnels may be configured on the overlay network. Each tunnel includes a set of certain links between two endpoints thereof. The tunnel endpoints could be actual physical locations, such as a network port, or they could be logical locations designated by a software address in the networking cloud. In some embodiments, the Customer AS 120 also includes an SDN, for example an SDN-WAN. However, it will be appreciated that the present disclosure can be applied in any type of networks without departing from the scope of the present disclosure. In SDN or SDN-WAN, configuration and reconfiguration of a Layer 2 tunnel can be achieved by the application level.

According to embodiments of the present disclosure, a tunnel on the overlay network can be pre-assigned to data associated with one or more external autonomous systems, one or more particular applications or otherwise one or more particular data groups. In the illustrated example, the tunnel 115 may have a fixed set of links selected by the customer entity and/or resulting from negotiation with Carrier X. The tunnel 115 is used for specific one or more data groups, e.g., data coming from particular external autonomous systems. The present disclosure is not limited to any specific means to define a tunnel, nor limited to any specific configuration or implementation of a tunnel. Therefore, data received from the Customer AS 120 can traverse the Carrier X AS 120 along the customer-selected set of links in the tunnel. Similarly, data destined for the Customer AS 120 can also be routed through the tunnel 115.

More specifically, for a data packet originating from a user device located in the Customer AS 120, a router (not shown) of the AS 120 assigns a private IP addresses to the user device. The packet is transmitted through the Customer AS BGP router 121 and the Carrier X BGP router 150 before reaching the Carrier X AS. In some embodiments, the Carrier X BGP router (or a core router or any other suitable type of router) is configured with tagging logic 151 and port forwarding policies module 152. The port forwarding policies may specify the correspondence between a tunnel (and/or an associated layer 2 port and an edge router in the Carrier X AS) and an AS, and may specify a priority policy for port forwarding.

The tagging logic 151 adds a tag to a class of data packets that needs to be routed through a specific tunnel in the Carrier X AS. In this example, thus, the tag indicates the packet's association with Customer AS 121. The tagging logic 151 may be configured to analyze the packet based on a set of information contained in the packet to decide whether it should be routed by using a pre-assigned tunnel (e.g., tunnel 115) and therefore whether a tag should be added. For example, the tagging logic 151 may classify the packet by using the 5-tuple of the packet, including a source IP address/port number, destination IP address/port number and the protocol in use. However, this discussion is merely exemplary. The tagging logic may use any other suitable types of information for purposes of tagging a packet. Once it is decided the packet should be forwarded to the tunnel 115, a corresponding tag is added to the packet. The tag may be in any suitable form that is recognizable by the switch device.

The BGP router 150 then sends the tagged packet to the network switch 160 configured at the boundary of the Carrier X AS 110. Particularly, the packet is received at a Layer 2 port of a network switch 160. The network switch 150 further includes port forwarding logic 160 and detagging logic 161. The port forwarding logic 161 can then detect the tag in the packet, and accordingly execute port forwarding to forward the data from the received Layer 2 port to another Layer 2 port that is coupled to the tunnel, referred to as tunnel endpoint port herein, thereby propagating the packet through the tunnel. The tunnel end points may be implemented in edge routers or non-edge routers. In this example, the end points of the tunnel 115 are implemented in the edge router 112 of the Carrier X AS 110. The router 112 does not change the IP address of the packet. The detagging logic 162 can remove the tag from the packet once it is no longer needed for port forwarding. It will be appreciated that the tagging logic and the port forwarding logic may reside on one or more other suitable network devices.

In some other embodiments, for example when the data traffic is small, the data is analyzed at a router to determine whether it should be forwarded to a particular tunnel, but the data is not tagged or detagged.

In some embodiments, if the destination node is located within the Carrier X AS 110, the tunnel may have the other endpoint resident on a non-edge router in Carrier X AS 110. The non-edge router can then direct the packet to the destination node in any manner that is well known in the art. If the destination node is located in a third AS (e.g., Carrier Y 130 or Carrier Z 140), the tunnel 115 may have the other endpoint resident on an edge router 114 of the Carrier X AS 110, as shown. However, the present disclosure is not limited thereto; a tunnel can be configured in any suitable scale any in any manner without departing from the scope of the present disclosure.

If the packet needs to, traverse, or be delivered at Carrier Z AS 140 which does not have a tunnel pre-assigned to the Customer AS 120, the packet propagates through the Carrier X BGP router 116 and the Carrier Z BGP router 141 before arriving at the boundary of the Carrier Z AS 140. The IP address of the packet may be changed by an edge router of the Carrier Z AS 140, as in the conventional system.

On the other hand, Carrier Y AS 130 similarly has a tunnel 131 pre-assigned to the Customer AS 120, and the tunnel 131 is built between the edge router 132 and a non-edge router 133. For example, at the exit of the tunnel, the router 133 can direct the packet to the destination node within the Carrier Y AS 130. A Carrier Y BGP router 170 is coupled to a Carrier X BGP router 116. The BGP router 170 includes tagging logic 171 and a port forwarding policies module 172, and a network switch 180 includes port forwarding logic 181 and detagging logic, similar as described with reference to the BGP router 150 and switch 160. The tunnel 131 may include a fixed set of links that are pre-selected by the customer entity of AS 120.

Because the a pre-assigned tunnel built on an overlay network of an AS (Carrier X AS in this example) is used to transport data to and from an external AS (Customer AS in this example), the external AS is advantageously offered with flexibility of controlling data routing in the instant AS based on its various business needs. Since any routing change can be performed by reconfigure the tunnel, it does not require changing of the routing table by the Carrier X and thus does not impose substantial operational cost of both parties. Further, since the data routing is controlled by Layer 2 switch operations (e.g., port forwarding) instead of using a routing table which involves Layer 3 operations, data exiting the tunnel can advantageously preserve its original source IP address assigned by the Customer AS 120.

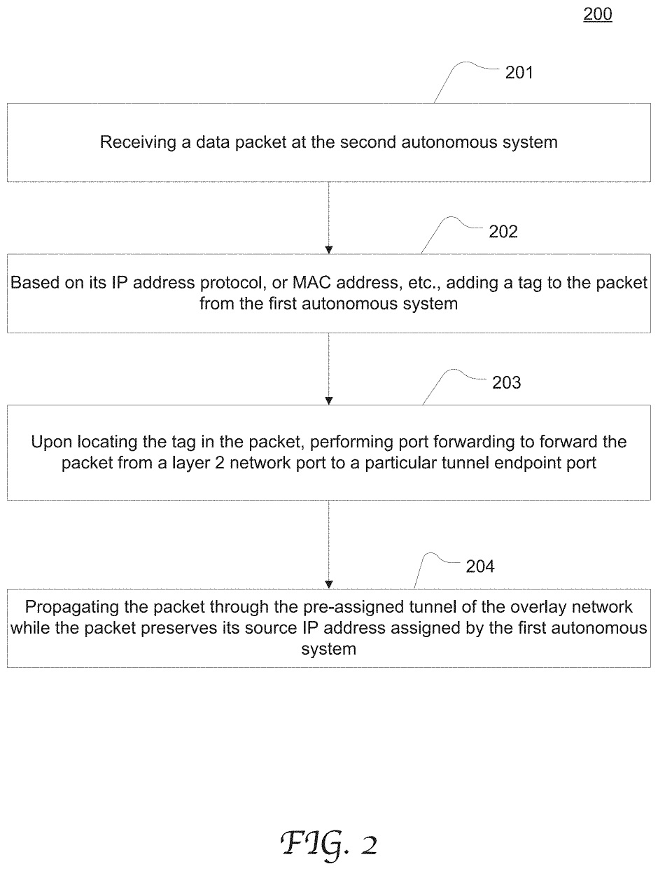

FIG. 2 is a flow chart depicting an exemplary computer implemented process 200 of routing data received from an external AS by using a pre-assigned tunnel built on an overlay network in accordance with an embodiment of the present disclosure. For instance, a data packet is routed across the first and the second autonomous systems. The second AS has an overlay network, on top of which a layer 2 tunnel is built. According to the pre-defined routing policy, any data from the first AS is routed through the tunnel. However, this is merely exemplary, the tunnel may also be responsible for transporting forwarded data that is associated with a predefined application, or a predefined data group. Process 200 may be performed by one or more network devices at the boundary of the second AS. Process 200 and may be implemented by using software, hardware, firmware, or a combination thereof in any suitable manner that is well known in the art.

At 201, the second AS receives a data packet at its boundary, e.g., at a BGP router (e.g., BGP router 150 in FIG. 1). The data packet carries a source IP address assigned by a router at the first AS. At 202, it is determined whether the packet is associated with the first AS and therefore needs to be directed to the tunnel pre-assigned to the first AS. The decision may be made based on the 5-tuple of the packet, including a source IP address/port number, destination IP address/port number and the protocol in us, or any other suitable information. In some embodiments where tagging logic is available, if the packet is from the first AS, the packet is tagged to indicate its association with the first AS. At 203, based on the analysis result of the packet or upon locating the tag in the packet, port forwarding is performed to switch the packet from the receiving Layer 2 port to a Layer 2 port that is coupled to the tunnel endpoint.

At 204, the packet is propagated through the tunnel in the overlay network along the fixed link selected for, or by, the first AS entity. Since the data routing is controlled by Layer 2 switch operations (e.g., port forwarding) in combination with a tunnel, as opposed to using a routing table which involves Layer 3 operations in the conventional art, data exiting the tunnel can advantageously preserve its original private IP address in its Layer 3 header, the private IP being associated with the first AS.

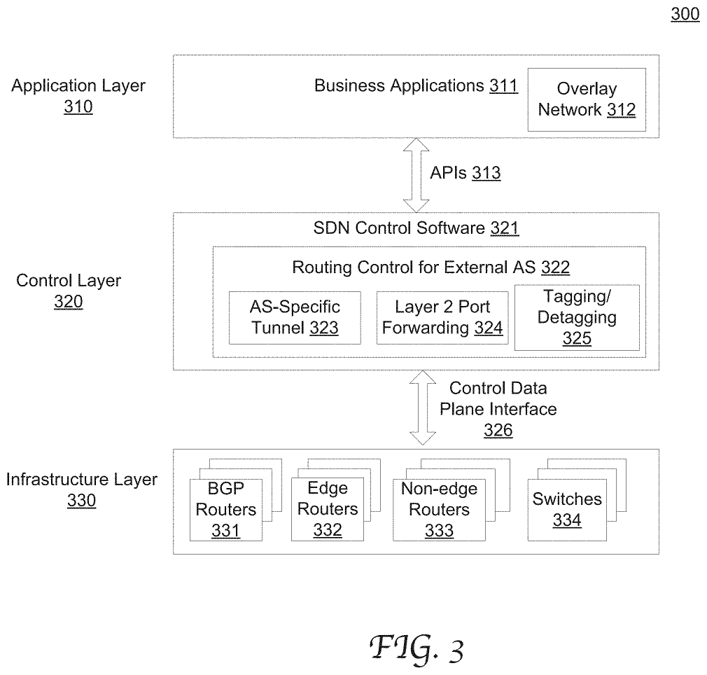

FIG. 3 is a block diagram illustrating an exemplary architecture of an SDN 300 configured to route data from an external AS by Layer 2 port forwarding to a pre-assigned tunnel in accordance with an embodiment of the present disclosure. For example, the SDN may be implemented in Carrier X AS 110 shown in FIG. 1. The SDN 400 includes three logic layers: the application layer 310, the control layer 320, and the infrastructure layer 330. The control layer 320 serves as the interface between the application layer 310 and the infrastructure layer 330 and controls the data to, and from, and external AS (e.g., Customer AS 120 in FIG. 1).

The infrastructure layer 330 includes the network hardware devices 331-334 coupled in the network, e.g., BGP routers, edge routers, non-edge routers and switches. The devices perform the forwarding and data processing capabilities for the network. This includes forwarding and processing of the data path.

The control layer 430, or the SDN controller, can offer proprietary programming interfaces to network devices and management functionalities. Under the control by the control layer 320, some devices are configured to perform analyzing and optionally tagging of data from a specific AS, Layer 2 port forwarding to a pre-assigned tunnel and optionally detagging.

The control layer 320 communicates with the network devices through a control data plane interface, e.g., by using the OpenFlow protocol. The control layer 320 includes one or more SDN control software programs that implement a distributed or centralized control system. Particularly, the control layer 320 includes a program 322 of routing control for external AS, which includes instructions to implement an AS-specific tunnel 323 with pre-selected links by the entity of the AS, a Layer 2 port forwarding control module 324, and a tagging/detagging control module 325.

In general, the applications can build an abstracted view of the network by collecting information from the controller for decision-making purposes. These applications could include networking management, analytics, network security, business applications used to run large data centers. The application layer 310 includes a business application program that creates an overlay network 312. The application layer 310 communicates with the control layer through respective application program interfaces (APIs).

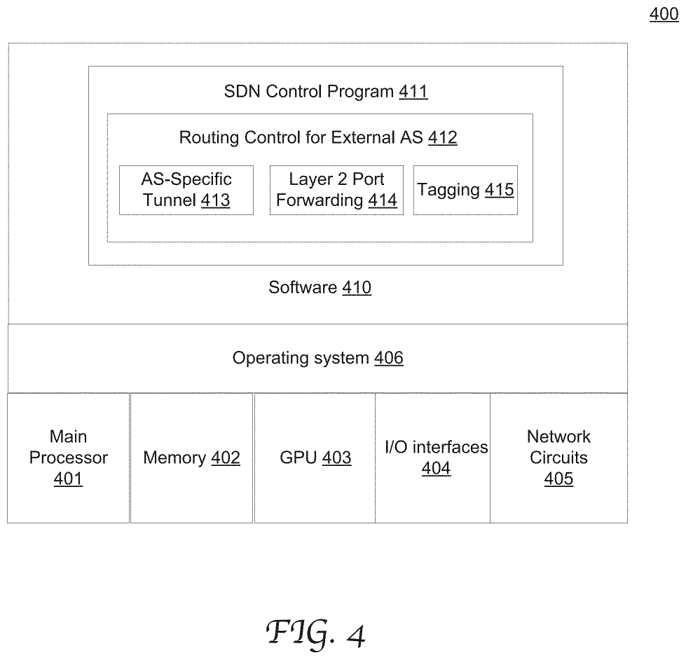

FIG. 4 is a block diagram illustrating the configuration of an exemplary SDN central controller device 400 capable of control network devices to route external AS data by using Layer 2 port forwarding and a pre-assigned tunnel according to an embodiment of the present disclosure. The device 400 may be a general-purpose server computer and operates in the control layer in the SDN network of the present AS. The SDN Controller 400 is a logical entity that receives instructions or requirements from the SDN Application layer and relays them to the networking infrastructure. The controller also extracts information about the network from the hardware devices and communicates back to the SDN Applications with an abstract view of the network, e.g., statistics and events about the network.

The SDN controller 400 includes a main processor 401, system memory 402, a graphics processing unit (GPU) 403, I/O interfaces 404 and network circuits 405, an operating system 406 and application software 410. The application software 410 includes SDN control program 411 stored in the memory 402. When executed by the main processor 401, the control program 411 can communicate with SDN routers and switches to control the data flow to and from an external AS.

More specifically, the central control program 411 program includes a module 412 of routing control for the external AS. The module 412 has a tunnel 413 configured on the overlay network and designated to transport date for the external AS. The module 412 also includes a Layer 2 port forwarding module 414 that specifies the port forwarding policies and can control a Layer 2 switch device to perform port forwarding regarding the external AS and the tunnel. Further included in a tagging/detagging module 415 that can control a router and/or a switch to tag or detag data, to and from, the external AS.

It will be appreciated that the central controller program 411 may include a wide range of other modules and functions that are well known in the art. Techniques for implementing these programmed modules are well known in the art. As will be appreciated by those with ordinary skill in the art, the central controller program 411 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of data routing across different autonomous systems, said method comprising:
in a first autonomous system, receiving a data packet from a second autonomous system;
analyzing said data packet to determine whether said data packet is associated with a data group, wherein said data packet comprises a source Internet Protocol (IP) address assigned by said second autonomous system, wherein said data group is pre-assigned with a tunnel configured on an overlay network within said first autonomous system;
performing Layer 2 port forwarding to forward said data packet from a layer 2 network port to a tunnel endpoint port of said tunnel; and
sending said data packet from said tunnel endpoint port to traverse said tunnel, wherein said tunnel comprises a predefined route associated with said first autonomous system.

2. The computer implemented method of claim 1, wherein said data packet traverses through said tunnel in said first autonomous system without subject to IP address change by any router in said first autonomous system.

3. The computer implemented method of claim 1, wherein said tunnel endpoint port is a layer 2 endpoint port.

4. The computer implemented method of claim 1, further comprising: prior to said Layer 2 port forwarding, adding a tag to said data packet to indicate association of data packet with said second autonomous system.

5. The computer implemented method of claim 4, wherein said performing Layer 2 port forwarding is based on detecting said tag in said data packet.

6. The computer implemented method of claim 4, further comprising removing said tag from said data packet after said Layer 2 port forwarding.

7. The computer implemented method of claim 1, wherein said first autonomous system comprises a software defined network (SDN) that comprises said overlay network.

8. The computer implemented method of claim 1, wherein analyzing said data packet comprises analyzing one or more of: said source IP address; a Media Access Control (MAC) address; a protocol in use; and a tag in said data packet, and wherein said data group comprise data routed from said second autonomous system.

9. The computer implemented method of claim 1, wherein said data packet is communicated to said first autonomous system by using Border Gateway Protocol (BGP).

10. The computer implemented method of claim 1, wherein said data packet is routed from said second autonomous system through a third autonomous system prior to being received at said Layer 2 network port associated with said first autonomous system.

11. An SDN control system in an SDN of a first autonomous system, said system comprising:
a processor;
memory coupled to said processor and storing instructions that, when executed by said processor, cause the SDN to perform a method of control data routing across multiple autonomous systems, said method comprising:
receiving a data packet from a second autonomous system;
analyzing said data packet to determine whether said data packet is associated with a data group, wherein said data packet comprises a source Internet Protocol (IP) address assigned by said second autonomous system, wherein said data group is pre-assigned with a tunnel configured on an overlay network within said first autonomous system;
performing Layer 2 port forwarding to forward said data packet from a layer 2 network port to a tunnel endpoint port of said tunnel; and
sending said data packet from said tunnel endpoint port to traverse said tunnel, wherein said tunnel comprises a predefined route associated with said first autonomous system.

12. The SDN control system of claim 11, wherein said data packet preserves said source IP address assigned by said second autonomous system while traversing through said tunnel in said first autonomous system.

13. The SDN control system of claim 11, wherein said tunnel endpoint port is a Layer 2 endpoint port.

14. The SDN control system of claim 11, wherein said method further comprises, prior to said port forwarding, adding a tag to said data packet to indicate association of data packet with said second autonomous system.

15. The SDN control system of claim 11, wherein said performing Layer 2 port forwarding is based on locating said tag in said data packet.

16. The SDN control system of claim 14, wherein said method further comprises removing said tag from said data packet after said port forwarding.

17. The SDN control system of claim 11, wherein said first autonomous system comprises a software defined network (SDN) that comprises said overlay network.

18. The SDN control system of claim 11, wherein analyzing said data packet comprises analyzing one or more of: said source IP address; a Media Access Control (MAC) address; and tags in said data packet, and wherein said data group comprises data routed from said second autonomous system.

19. The SDN control system of claim 11, wherein said data packet is communicated to said first autonomous system by using Border Gateway Protocol (BGP).

20. The SDN control system of claim 11, wherein said data packet is routed from said second autonomous system through a third autonomous system prior to being received at said layer 2 network port associated with said first autonomous system.
